(19) United States
(12) Patent Application Publication
(10) Pub. No.: US 2026/0321845 A1
(43) Pub. Date: Oct. 15, 2026

(54) Rechargeable Battery Pack for Supplying Electrical Drive Power to an Electrically Driven Piece of Work Equipment, And System Comprising the Rechargeable Battery Pack

(71) Applicant: Andreas Stihl AG & Co. KG, Waiblingen (DE)

(72) Inventors: Tobias WUERSCHUM, Neubulach (DE); Victor PETERS, Tamm (DE); Sebastian SCHENK, Schorndorf (DE); Kathrin BEUTEL, Wangen (DE); Radu BARZA, Waiblingen (DE); Nils FREY, Stuttgart (DE); Dennis LANG, Remshalden (DE); Lars Valentin HUTT, Weinstadt (DE); Gerhard STUEBS, Korb (DE); Friedhelm KOCH, Allmersbach im Tal (DE)

(21) Appl. No.: 19/644,006

(22) Filed: Apr. 10, 2026

(30) Foreign Application Priority Data
Apr. 11, 2025 (DE) 10 2025 114 353.6

(51) Int. Cl. H01M 50/247; H01M 10/42; H01M 50/519

(52) U.S. Cl. CPC H01M 50/247; H01M 10/425; H01M 50/519; H01M 2010/4271; H01M 2220/30

(57) ABSTRACT

A rechargeable battery pack supplies electrical drive power to an electrically driven piece of work equipment. The rechargeable battery pack has rechargeable battery cells, electrical cell contactors, and an FPC connector. The cell contactors are electrically connected to the rechargeable battery cells. The FPC connector is electrically connected to the cell contactors in each case by resistance welding joints produced from above via welding electrodes. The rechargeable battery pack has a cell holder that holds the rechargeable battery cells. The cell holder is formed as a welding support for producing the resistance welding joints. The cell holder is arranged physically below the cell contactor and the FPC connector, and/or the FPC connector has electrically conductive connector welding surfaces, wherein the connector welding surfaces each extend continuously between welding points of the resistance welding joints with a respective cell contactor of the cell contactors, in particular wherein the cell contactors are physically arranged below the connector welding surfaces to produce the resistance welding joints.

### CROSS REFERENCE TO RELATED APPLICATION

This application claims priority under 35 U.S.C. § 119 from German Patent Application No. 10 2025 114 353.6, filed Apr. 11, 2025, the entire disclosure of which is herein expressly incorporated by reference.

### FIELD OF APPLICATION

The invention relates to a rechargeable battery pack for supplying electrical drive power to an electrically driven piece of work equipment and to a system comprising the rechargeable battery pack.

### PROBLEM AND SOLUTION

The invention is based on the object of providing a rechargeable battery pack for supplying electrical drive power to an electrically driven piece of work equipment, and a system comprising the rechargeable battery pack which, in particular each of which, have improved properties.

The invention solves this problem by providing a rechargeable battery pack as described in the independent claim. Advantageous developments of the invention are described in the dependent claims.

The rechargeable battery pack according to the invention is designed, in particular, to supply electrical drive power to an electrically driven piece of work equipment. The rechargeable battery pack comprises rechargeable battery cells, electrical cell contactors and an FPC connector. The cell contactors are electrically connected to the rechargeable battery cells. The FPC connector is electrically connected, in particular directly, to each of the cell contactors by means of resistance welding joints by means of welding electrodes from above produced.

In addition, the rechargeable battery pack has at least one cell holder. At least the cell holder holds the rechargeable battery cells. At least the cell holder is formed, in particular integrally, as at least one welding support for producing the resistance welding joints. At least the cell holder is physically arranged, in particular directly, below the cell contactors and the FPC connector, in particular their resistance welding joints to one another.

Again in addition or as an alternative, the FPC connector has electrically conductive connector welding surfaces. The connector welding surfaces each extend continuously between welding points of the resistance welding joints with a respective cell contactor of the cell contactors. In particular, the cell contactors are physically arranged, in particular directly, below the connector welding surfaces for producing the resistance welding joints.

This enables the FPC connector to be electrically connected to the rechargeable battery cells, in particular by means of the cell contactors.

In addition or as an alternative, this enables, in particular, the cell holder to be formed as the welding support, simplicity of the production of the resistance welding joints and thus of the rechargeable battery pack and/or a multifunction of the cell holder or enables the rechargeable battery pack to be able not to have a separate or extra welding support, and therefore a simple design with only a few components.

Again in addition or as an alternative, this enables, in particular, the connector welding surfaces to each extend continuously between the welding points of the resistance welding joints with a respective cell contactor of the cell contactors, simplicity and/or stability of the production of the resistance welding joints and thus of the rechargeable battery pack and/or a simple design of the connector welding surfaces and thus of the FPC connector and thus of the rechargeable battery pack.

In particular, the term “battery pack” may be used synonymously for the term “rechargeable battery pack”.

The rechargeable battery pack may be mobile or portable.

Mobile may mean a mass of at most 50 kg (kilograms), in particular at most 20 kg, in particular at most 10 kg, in particular at most 5 kg, and/or at least 0.2 kg, in particular at least 0.5 kg, in particular at least 1 kg, in particular at least 2 kg, in particular 0.8-1.9 kg.

The rechargeable battery pack and/or the rechargeable battery cells may be rechargeable.

The rechargeable battery cells may each be electrochemical-based individual rechargeable storage elements for electrical energy. In addition or as an alternative, the battery cells may be lithium-ion battery cells. Again in addition or as an alternative, the battery cells may be identical, in particular of the same type and/or construction. Again in addition or as an alternative, an, in particular respective, cell voltage, in particular cell rated voltage, of an, in particular respective, one of the rechargeable battery cells may be at least 2 V (volts) and/or at most 4 V, in particular 3.6 V.

The supply may be automatic.

The term “configured”, “set up” or “intended” or the phrase “programmed to perform the function/s of” may be used synonymously for the term “designed”.

The term “comprises” may be used synonymously for the term “has” or “contains”.

The cell contactors may be electrically conductive.

The cell contactors may be mechanically connected to the rechargeable battery cells.

The FPC connector may be mechanically connected to each of the cell contactors by means of the resistance welding joints and/or the FPC connector may be secured to each of the cell contactors.

The FPC connector may not be a cable harness and/or the rechargeable battery pack may not have a cable harness.

The term “flexible circuit board” or the term “conductor film” may be used synonymously for the term “FPC connector” (FPC short for flexible printed circuit).

The welding electrodes may be, in particular exactly, two welding electrodes and/or the welding points may be, in particular exactly, two welding points.

The welding electrodes may be placed on the FPC connector.

The term “external” may be used synonymously for the term “above”.

The term “immediately” may be used synonymously for the term “directly”.

The cell contactors may be secured to at least the cell holder.

The cell holder, in particular the welding support, may be electrically insulating.

The at least one welding support may be welding supports and/or flat.

The term “welding substrate” may be used synonymously for the term “welding support”.

The term “internal” may be used synonymously for the term “below”.

The component of the term “connecting surfaces” may be used synonymously for the component of the term “welding surfaces”.

The component of the term “pads” can be used synonymously for the component of the term “surfaces”.

The FPC connector may have an electrically insulating carrier that can carry the connector welding surfaces.

The connector welding surfaces may be flat, copper connector welding surfaces, printed and/or not connector welding surface plates.

The term “connecting points” may be used synonymously for the term “welding points”.

The phrase “without a cut or a physical interruption” or the term “in one piece” may be used synonymously for the term “continuous”.

The term “run” may be used synonymously for the phrase “extend”.

Reference is also made to the specialist literature.

In one development of the invention, the rechargeable battery pack has a battery management system. The battery management system is designed to detect electrical measurement signals, in particular cell voltages, of the rechargeable battery cells. The FPC connector comprises at least electrical measurement conductor paths. At least the measurement conductor paths and the cell contactors, and in particular the connector welding surfaces, provide at least electrical measurement connections of the battery management system to the rechargeable battery cells, in particular a measurement connection of the measurement connections of the battery management system to each rechargeable battery cell of the rechargeable battery cells. At least the measurement conductor paths and the cell contactors, and in particular the connector welding surfaces, are designed to transmit at least the measurement signals, in particular to detect the measurement signals. In other words: By means of at least the measurement conductor paths and the cell contactors, the battery management system and the rechargeable battery cells comprise at least the measurement connections to one another for the transmission of at least the measurement signals. This enables the FPC connector to function. In particular, the battery management system may be electrical, in particular electronic, and/or have a measurement electronics device. In addition or as an alternative, the detection and/or transmission may be automatic. Again in addition or as an alternative, the term “measurement” may be used synonymously for the term “detection”. In addition or as an alternative, the measurement signals may be temperatures and/or have values. Again in addition or as an alternative, the cell voltages may be average voltages and/or individual cell voltages. Again in addition or as an alternative, the battery management system may be designed to determine states of charge, in particular individual states of charge, of the rechargeable battery cells. Again in addition or as an alternative, the battery management system and the FPC connector may be completely different. Again in addition or as an alternative, the FPC connector may comprise the electrically insulating carrier which can carry at least the measurement conductor paths. Again in addition or as an alternative, the measurement conductor paths may be electrically conductive and/or copper conductor paths. Again in addition or as an alternative, the measurement conductor paths can extend up to the cell contactors and/or the connector welding surfaces in each case. Again in addition or as an alternative, each of the measurement conductor paths may be electrically connected to each of the connector welding surfaces, in particular in an interlocking manner and/or in an integrally formed manner. Again in addition or as an alternative, at least the measurement conductor paths may extend up to the battery management system. In addition or as an alternative, each of the measurement conductor paths can be soldered to the battery management system. Again in addition or as an alternative, the battery management system may be secured to the cell holder.

In one development of the invention, the FPC connector has overcurrent protection fuses. The overcurrent protection fuses are designed to interrupt at least the measurement conductor paths or the measurement connections, in particular in each case and/or to interrupt the transmission at least of the measurement signals, to protect the battery management system, and in particular therefore the rechargeable battery pack and/or the rechargeable battery cells, against an electrical overcurrent. This enables at least one short circuit to be intercepted. In particular, in each case one overcurrent protection fuse of the overcurrent protection fuses can be arranged, in particular electrically, between the battery management system and each cell contactor of the cell contactors.

In one development of the invention, the cell contactors are electrical cell connectors. The cell connectors electrically connect the rechargeable battery cells to one another in series and/or in parallel. This enables a multifunction of the cell contactors. In particular, the term “interconnected” can be used synonymously for the term “connected”.

In one development of the invention, the cell contactors are rigid, in particular cell contactor plates. In particular, the term “inflexible” can be used synonymously for the term “rigid”.

In one development of the invention, the cell holder is formed as the welding support continuously below, in particular between, at least two cell contactors of the cell contactors. The FPC connector does not extend continuously above or below, in particular between, the two cell contactors. This, in particular the fact that the cell holder, in the form of the welding support, extends continuously below the two cell contactors, enables particular simplicity of the production of the resistance welding joints and/or a particularly simple design of the rechargeable battery pack with particularly few components. This, in particular the fact that the FPC connector does not extend continuously above or below the two cell contactors, makes it possible to avoid or prevent formation of a gap between the cell holder, in the form of the welding support, and the FPC connector and thus a moisture film in the gap and thus a bypass by way of the moisture film and thus a short circuit between the two cell contactors and/or two respective connector welding surfaces of the connector welding surfaces.

In one development of the invention, the FPC connector comprises the electrically insulating carrier. The carrier carries the connector welding surfaces by their edges. The carrier has apertures, in particular windows, below or above their centres designed for producing the resistance welding joints. The cell contactors are physically arranged below the connector welding surfaces, in particular their centres and/or the apertures, in particular directly, in order to produce the resistance welding joints. This enables particularly simple production of the resistance welding joints. In particular, the term “substrate” may be used synonymously for the term “carrier”.

In one development of the invention, for producing the resistance welding joints, the connector welding surfaces, in particular each, have a thickness of at most 150 μm (micrometre), and in particular at least 18 μm, in particular at least 35 μm, in particular 70 μm, and/or a width of at least 1.5 mm (millimetre) and/or at most 10 mm, in particular 4 mm, and/or a length of at least 2 mm and/or at most 30 mm, in particular 12 mm. In addition or as an alternative, for producing the resistance welding joints, electrically conductive contactor welding surfaces of the cell contactors, in particular each, have a thickness of more than 150 μm, and in particular at most 750 μm, in particular 300 μm, and/or a width of at least 3 mm and/or at most 15 mm, in particular 6 mm, and/or a length of at least 8 mm and/or at most 30 mm, in particular 16 mm. Again in addition or as an alternative, for producing the resistance welding joints, electrically insulating support surfaces of the at least one welding support, in particular each, have a thickness of more than 150 μm, and in particular at most 3 mm, in particular 0.9 mm, and/or a width of maximum 43 mm. This enables, in particular the length(s) and/or width(s) enable(s), positioning and/or orientation tolerance compensation, in particular in each direction, and/or an, in particular complete or full, overlap of the connector welding surfaces, the contactor welding surfaces and/or the support surfaces and/or good support and/or, in particular therefore, this enables, in particular the thickness(es) enables(s) a particular simplicity and/or a particular stability of the production of the resistance welding joints. In particular, the contact welding surfaces may be contact tabs. In addition or as an alternative, the contact welding surfaces and/or the support surfaces may be flat.

In one development of the invention, the electrically insulating support surfaces of the at least one welding support, in particular at least one wall of at least the cell holder, continuously extend in each case below the resistance welding joints more than between the welding points, in particular parallel to the cell contactors and the FPC connector. In particular, a length of the support surfaces is at least, in particular exactly, as long as the length of the connector welding surfaces and/or the electrically conductive contactor welding surfaces of the cell contactors for producing the resistance welding joints. In particular, the width of the support surfaces is at least, in particular exactly, as large as the width of the connector welding surfaces and/or the contactor welding surfaces. This enables positioning and/or orientation tolerance compensation, in particular in each direction, and/or an, in particular complete or full, overlap of the connector welding surfaces, the contactor welding surfaces and the support surfaces and/or good support and therefore this enables a particular simplicity and/or a particular stability of the production of the resistance welding joints. In particular, the at least one wall may be walls.

In one development of the invention, the cell contactors comprise the electrically conductive contact welding surfaces for producing the resistance welding joints. The contactor welding surfaces each continuously extend below the resistance welding joints at least, in particular precisely, between the respective connector welding surface of the connector welding surfaces, in particular parallel to the FPC connector. In particular, the length of the contactor welding surfaces is at least, in particular exactly, as long as the length of the connector welding surfaces. In particular, the width of the contactor welding surfaces is at least, in particular exactly, as large as the width of the connector welding surfaces. This enables positioning and/or orientation tolerance compensation, in particular in each direction, and/or an, in particular complete or full, overlap of the connector welding surfaces and the contactor welding surfaces and therefore this enables a particular simplicity and/or a particular stability of the production of the resistance welding joints.

In one development of the invention, the FPC connector has at least one aperture, in particular a through-hole. At least the aperture is designed to receive a positioning and/or orientation device, in particular from above, for positioning and/or for orientation of the FPC connector with respect to the cell contactors for producing the resistance welding joints. This enables the FPC connector to be held down or kept flat, or makes it possible that the FPC connector does not bulge or protrude in a rounded manner, and/or, in particular therefore, enables a particularly simple and/or particularly good production of the resistance welding joints. In particular, the aperture may be round or not round, in particular square. In addition or as an alternative, the reception may be temporarily in time with or during or in time with the production and no longer be provided thereafter. Again in addition or as an alternative, the received positioning and/or orientation device can be supported on at least the cell holder. Again in addition or as an alternative, the phrase “for physical arrangement” can be used synonymously for the phrase “for positioning and/or for orientation”. Again in addition or as an alternative, the battery management system, in particular a system circuit board of the battery management system, may have an additional aperture, in particular an additional through-hole, for positioning and/or for orientation of the battery management system. This enables the battery management system, together with the FPC connector, to be well positioned and/or oriented.

In one development of the invention, the FPC connector is of elongate design and secured by means of its longitudinal ends, in particular for producing the resistance welding joints. The resistance welding joints are physically arranged between the longitudinal ends. In particular, the FPC connector is secured by way of its first longitudinal end by means of the battery management system of the rechargeable battery pack. In addition or as an alternative, in particular, the FPC connector by way of its second longitudinal end is secured by means of at least one electrical pack data contact, in particular a plug connector, of the rechargeable battery pack, in particular of the FPC connector. This enables simple production and/or a good design of the rechargeable battery pack. In particular, the term “oblong” may be used synonymously for the term “elongate”. In addition or as an alternative, a length of the FPC connector may be greater than a width and/or a thickness of the FPC connector. Again in addition or as an alternative, secured may be mechanically secured. Again in addition or as an alternative, the term “positioned” may be used synonymously for the term “secured”. Again in addition or as an alternative, the FPC connector can be secured to the system circuit board of the battery management system. Again in addition or as an alternative, the pack data contact can be secured to a contact plate of the rechargeable battery pack, which contact plate can be secured to the cell holder. Again in addition or as an alternative, the battery management system may be designed to send data to the piece of work equipment and/or to receive data from the piece of work equipment. The pack data contact may be designed to make contact with an electrical equipment data contact of the piece of work equipment. The FPC connector may have at least one electrical data conductor path. At least the data conductor path may provide at least one electrical data connection of the battery management system to the pack data contact. At least the data conductor path may be designed to transmit the data, in particular to send and/or receive the data.

In one development of the invention, the rechargeable battery pack has an, in particular cuboid, cell block. The cell block comprises the rechargeable battery cells. From above to below is in the direction of the cell block. In addition or as an alternative, the connector welding surfaces are at least, in particular precisely, physically arranged on, in particular at, a block side of the cell block parallel to the block side, in particular a block circumferential side. This enables a space-saving design of the rechargeable battery pack. In particular, the term “cell assembly” may be used synonymously for the term “cell block”. In addition or as an alternative, the cell block may be of parallelepipedal shape. Again in addition or as an alternative, the FPC connector, in particular by way of at least the measurement conductor paths, at least on the, in particular first, block circumferential side of the cell block can extend over more than 50% (percent), in particular over at least 75%, in particular over 100%, of an extent from a first end of the block circumferential side to a second end of the block circumferential side. The block circumferential side or the first end may adjoin a first block front side of the cell block. The block circumferential side or the second end may adjoin a second block front side of the cell block. The second block front side may be located opposite the first block front side. In particular, the connector welding surfaces and/or the cell contactors may be physically arranged along the extent, in particular from the first end to the second end. Again in addition or as an alternative, the FPC connector may have an, in particular precisely, one, in particular flexible, connector circuit board. The connector circuit board may be physically arranged with its connector plate plane on, in particular at, the block circumferential side parallel to the block circumferential side. Again in addition or as an alternative, the term “outer side” may be used synonymously for the term “block circumferential side”. Again in addition or as an alternative, the term “front side” may be used synonymously for the term “block front side”. Again in addition or as an alternative, the battery management system may be physically arranged, in particular completely and/or precisely, on, in particular at, the first block front side. In particular, the battery management system may comprise at least, in particular precisely, the, in particular rigid, system circuit board. The system circuit board may be physically arranged with its system board plane parallel to the first block front side. Again in addition or as an alternative, the pack data contact may be physically arranged, in particular completely and/or accurately, on, in particular at, the second block front side. Again in addition or as an alternative, the cell block, in particular its cuboid shape, may be formed by at least the cell holder, and in particular the held rechargeable battery cells.

In one development of the invention, the rechargeable battery cells are, in particular elongate, round cells. The round cells each have cell terminals on their opposite cell front sides. In particular, the round cells are physically arranged in at least one common cell plane with their longitudinal cell axes parallel to one another. In particular, the round cells are physically arranged with their longitudinal cell axes parallel to the block circumferential side. In particular, the component of the term “contact” may be used synonymously for the component of the term “terminal”. In addition or as an alternative, the cell terminals may be physically arranged along the extent, in particular from the first end to the second end.

In one development of the invention, the rechargeable battery pack has a pack housing. The rechargeable battery cells, the cell contactors, the FPC connector and at least the cell holder are physically arranged in the pack housing. At least the cell holder has at least one holding part. At least the holding part holds the rechargeable battery cells. At least the cell holder has at least one spacer projection such that the pack housing, together with the at least one holding part, forms a gap. The FPC connector is physically arranged in at least one connector space created by means of the gap. This makes it possible to prevent the FPC connector from being sheared off by the cell contactors when it is placed in the pack housing. In particular, the pack housing may be an external pack housing. In addition or as an alternative, the pack housing may not have a spacer protrusion. Again in addition or as an alternative, the holding part and the spacer protrusion can be formed in one piece or integrally formed with one another. Again in addition or as an alternative, the spacer protrusion may protrude from the holding part from below to above. Again in addition or as an alternative, the FPC connector may be arranged above the holding part and/or below the pack housing. Again in addition or as an alternative, the component of the term “nose” or “elevation” may be used synonymously for the component of the term “projection”. Again in addition or as an alternative, the term “clearance” or “cavity” may be used synonymously for the term “connector space”. Again in addition or as an alternative, the term “extends” may be used synonymously for the phrase “is physically arranged”. Again in addition or as an alternative, the gap may be greater than zero.

In one development of the invention, the rechargeable battery pack comprises the pack housing. The rechargeable battery cells, the cell contactors and the FPC connector are physically arranged in the pack housing. The pack housing has guide grooves. The guide grooves running side by side are designed to guide the rechargeable battery pack for mechanical connection with the piece of work equipment. The FPC connector is, and in particular therefore the resistance welding joints and/or only, physically arranged between the guide grooves and not next to the guide grooves. This enables a space-saving design of the rechargeable battery pack. In particular, the guide grooves may be accessible from outside the pack housing, elongate recesses in the pack housing and/or not protrusions, in particular not rails, to the outside. In addition or as an alternative, the pack housing may have the guide grooves on exactly one housing side, in particular a first housing circumferential side. Again in addition or as an alternative, the phrase “parallel to one another” may be used synonymously for the term “side by side”. In addition or as an alternative, the FPC connector and the guide grooves may be parallel to one another. Again in addition or as an alternative, the FPC connector may be physically arranged within an intermediate space between the guide grooves and not outside the intermediate space. In addition or as an alternative, the FPC connector may have a maximum width of at most 100 mm, in particular 47 mm, and in particular a minimum width of at most 10 mm, in particular 3.5 mm. Again in addition or as an alternative, the FPC connector may have an, in particular precisely, one, in particular flexible, connector circuit board. A connector board plane of the connector circuit board may correspond to, in particular equate to, a groove plane defined by the guide grooves.

The system according to the invention comprises the rechargeable battery pack as previously mentioned and comprises an, in particular the, piece of work equipment and/or an electric charger. The charger is designed to supply electrical charging power to the rechargeable battery pack. In particular, the system, the piece of work equipment and/or the charger may be mobile. In addition or as an alternative, the piece of work equipment may have a work tool and/or an, in particular electric, drive motor, in particular for driving the work tool. In particular, the drive power may be for the drive motor. Again in addition or as an alternative, the piece of work equipment may be ground-guided and/or hand-operated, in particular hand-held, and/or a piece of gardening, forestry, construction and/or cultivation work equipment. In particular, the piece of work equipment may be a saw, in particular a chainsaw, or a pruner, or a hedge trimmer, or a hedge cutter, or a wood cutter, or pruning shears, or an angle grinder or a blower, or a leaf blower, or a vacuum cleaner, or a leaf vacuum, or a cleaning appliance, or a high-pressure cleaner, or a sweeper, or a sweeper roller, or a sweeping brush, or a lawnmower, or a grass trimmer, or a brush cutter, or a scarifier. Again in addition or as an alternative, the rechargeable battery pack and the piece of work equipment may be designed for electrical and/or mechanical connection to one another in a manner releasable in particular without the use of tools and/or non-destructively, in particular by way of a user. Again in addition or as an alternative, the rechargeable battery pack and the piece of work equipment and/or the charger may be designed to carry the rechargeable battery pack by way of the piece of work equipment and/or the charger and/or to remove and/or replace the rechargeable battery pack. In particular, the piece of work equipment and/or the charger may have a rechargeable battery slot which may be designed for receiving the rechargeable battery pack. Again in addition or as an alternative, the supply may be automatic.

Further advantages and aspects of the invention will become apparent from the claims and from the description of exemplary embodiments of the invention, which are explained below with reference to the figures.

### BRIEF DESCRIPTION OF THE DRAWINGS

FIG. 1 shows a perspective view of a rechargeable battery pack according to the invention for supplying electrical drive power to an electrically driven piece of work equipment without a pack housing,

FIG. 2 shows a view of a first block circumferential side of a cell block of the rechargeable battery pack,

FIG. 3 shows a view of an outer side or top side of a battery management system and an FPC connector of the rechargeable battery pack,

FIG. 4 shows a view of an inner side or bottom side of the battery management system and the FPC connector of the rechargeable battery pack, wherein the inner side is located opposite the outer side,

FIG. 5 shows another view of the inner side of the FPC connector,

FIG. 6 shows a perspective view of the rechargeable battery pack without the battery management system and without the FPC connector,

FIG. 7 shows a view of the first block circumferential side of the cell block without the battery management system and without the FPC connector,

FIG. 8 shows a perspective view of electrical cell connectors of the rechargeable battery pack,

FIG. 9 shows a view of the securing of the FPC connector to a cell connector of the cell connectors,

FIG. 10 shows a perspective view of a cell holder of the rechargeable battery pack,

FIG. 11 shows a perspective view of a contact plate of the rechargeable battery pack,

FIG. 12 shows a view of a second block circumferential side of the cell block with a housing cover of the pack housing, wherein the second block circumferential side is located opposite the first block circumferential side,

FIG. 13 shows a view of a second block front side of the cell block,

FIG. 14 shows a sectional view of the rechargeable battery pack with a housing container of the pack housing,

FIG. 15 shows a view of the second block front side of the cell block without a part of the housing container,

FIG. 16 shows a view of the second block front side of the cell block with the pack housing or a second housing front side of the pack housing,

FIG. 17 shows a view of a first housing front side of the pack housing, wherein the first housing front side is located opposite the second housing front side,

FIG. 18 shows a view of a first housing circumferential side of the pack housing,

FIGS. 19 to 21 show at least one view of at least one other housing circumferential side of the pack housing, and

FIG. 22 shows a schematic view of a system according to the invention comprising the rechargeable battery pack, the piece of work equipment and an electric charger for supplying electrical charging power to the rechargeable battery pack.

### DETAILED DESCRIPTION OF THE EXEMPLARY EMBODIMENTS

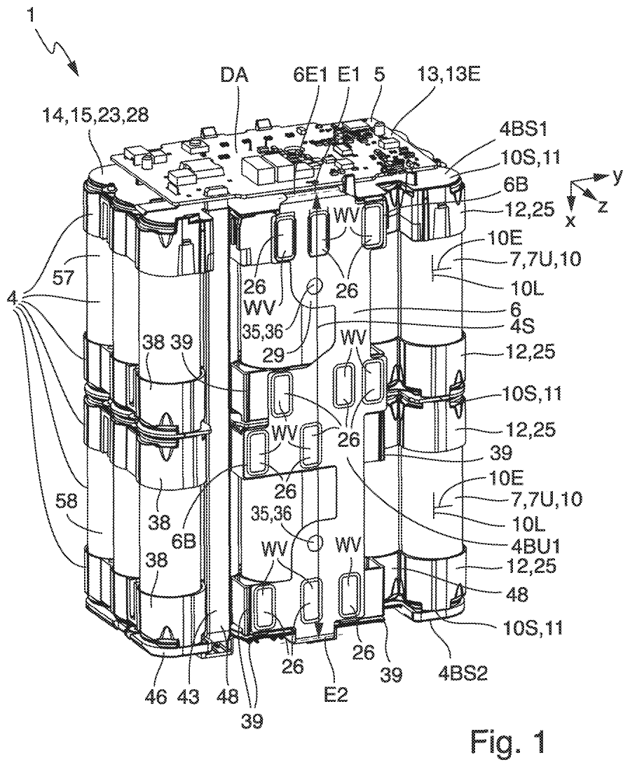

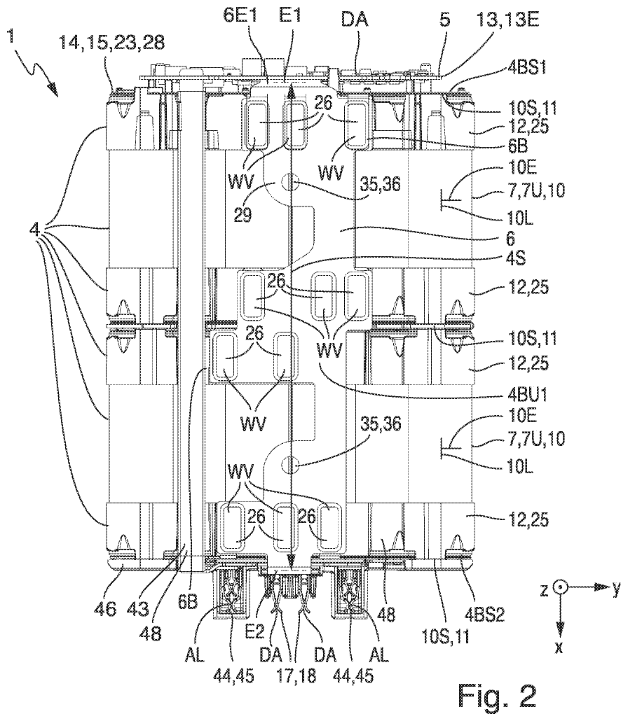

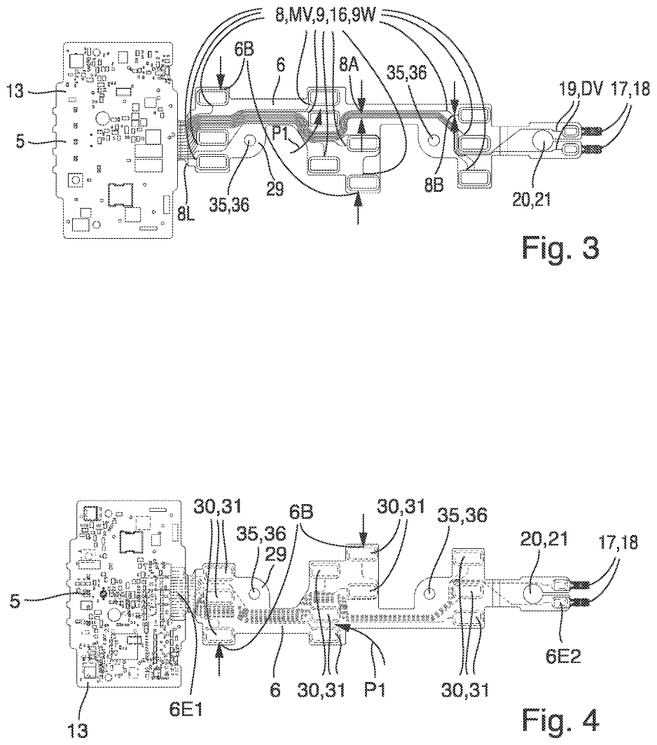

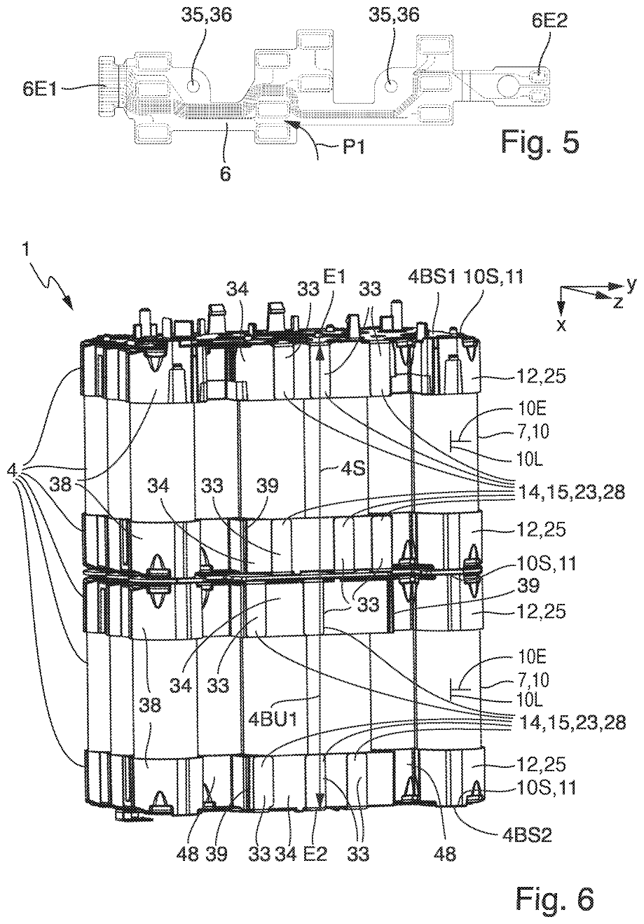

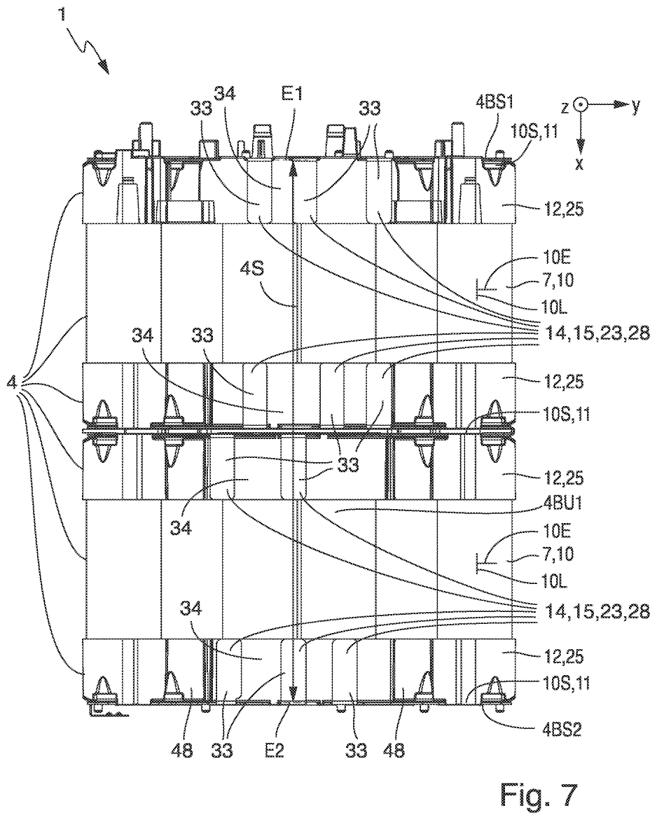

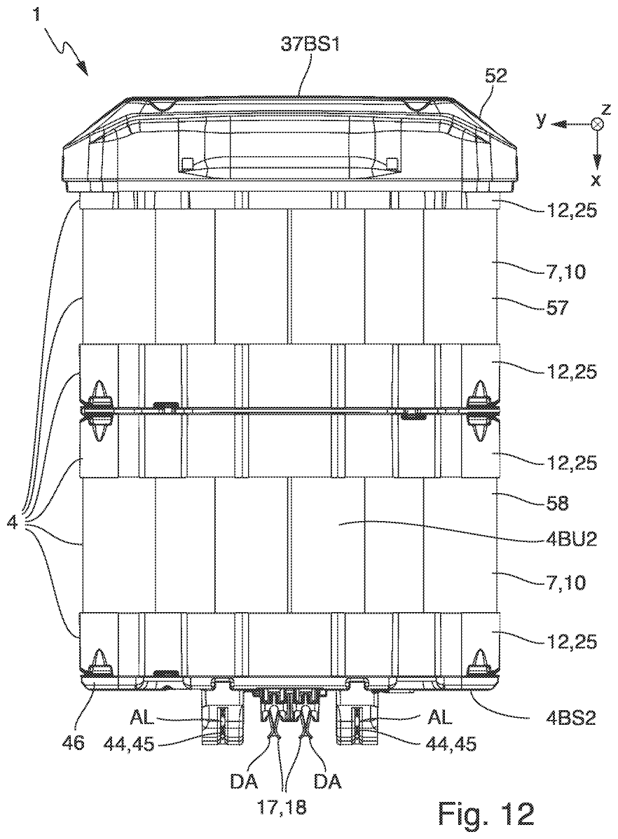

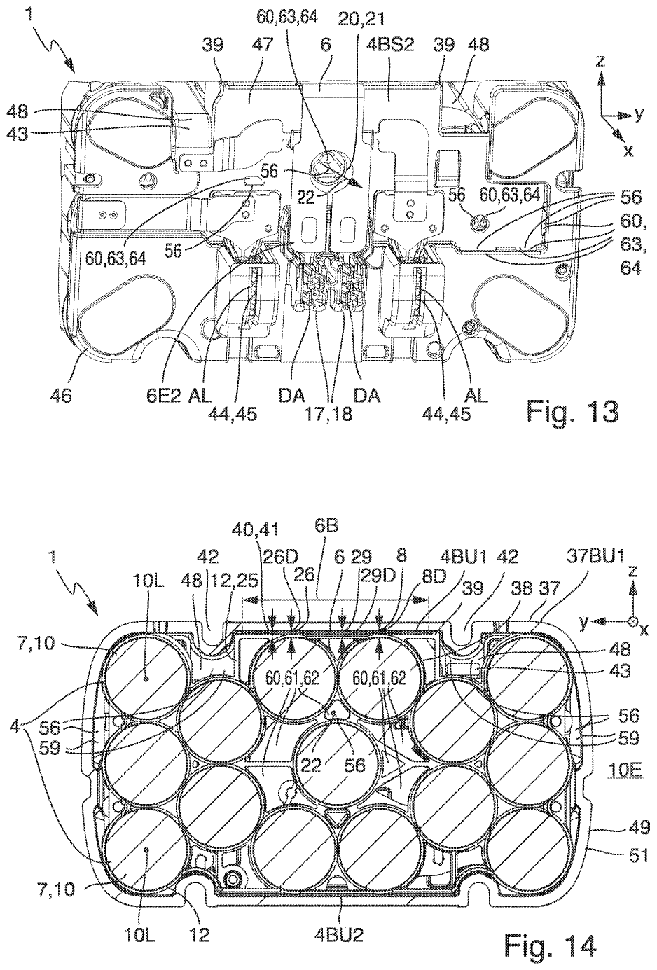

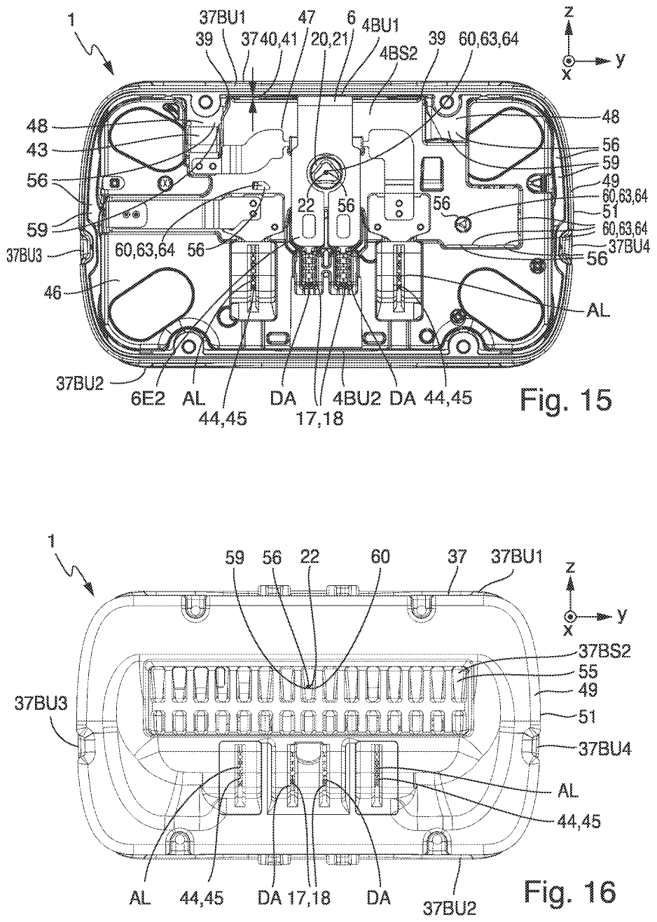

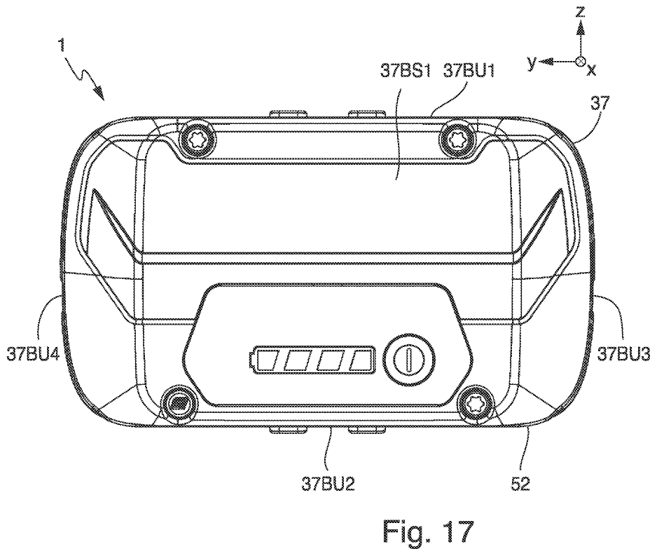

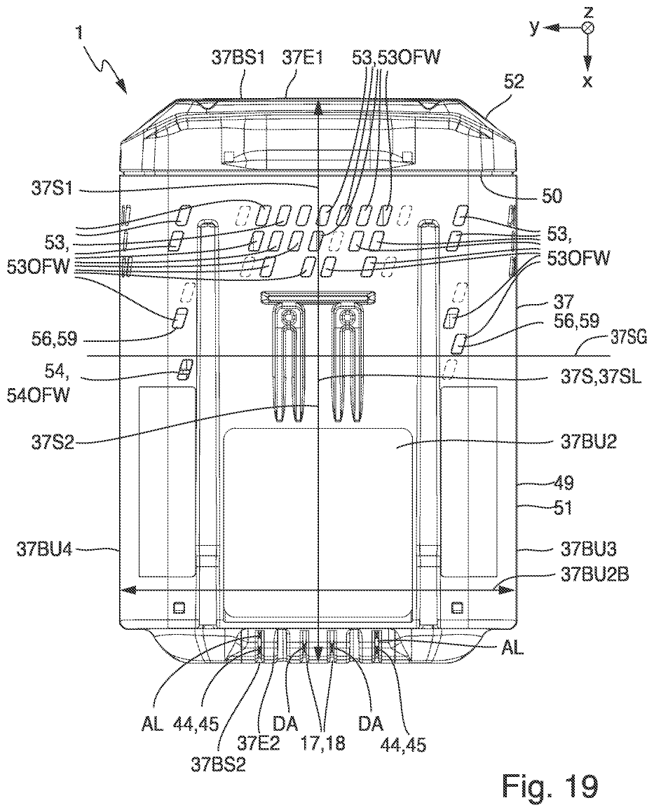

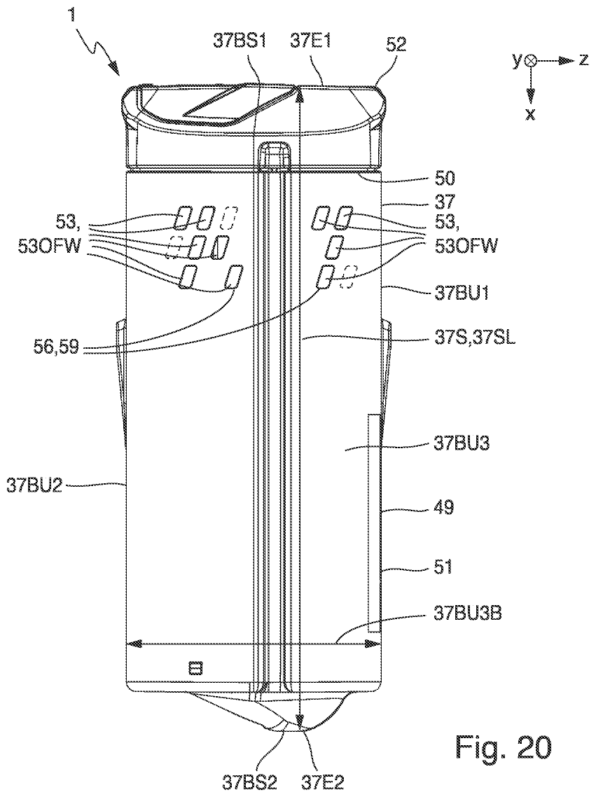

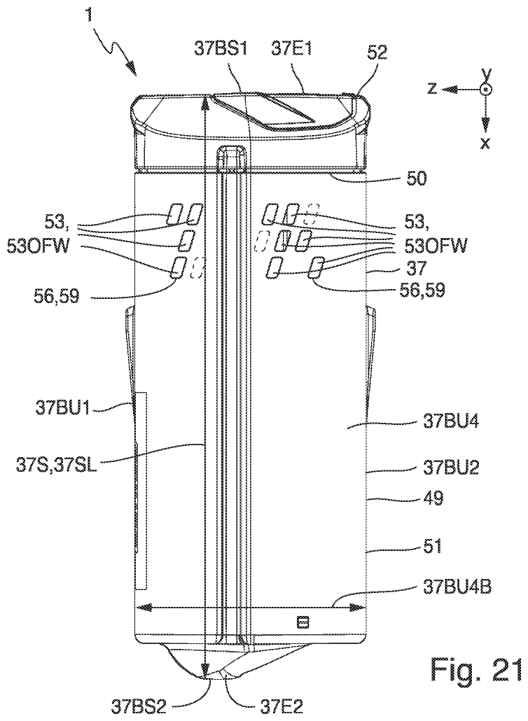

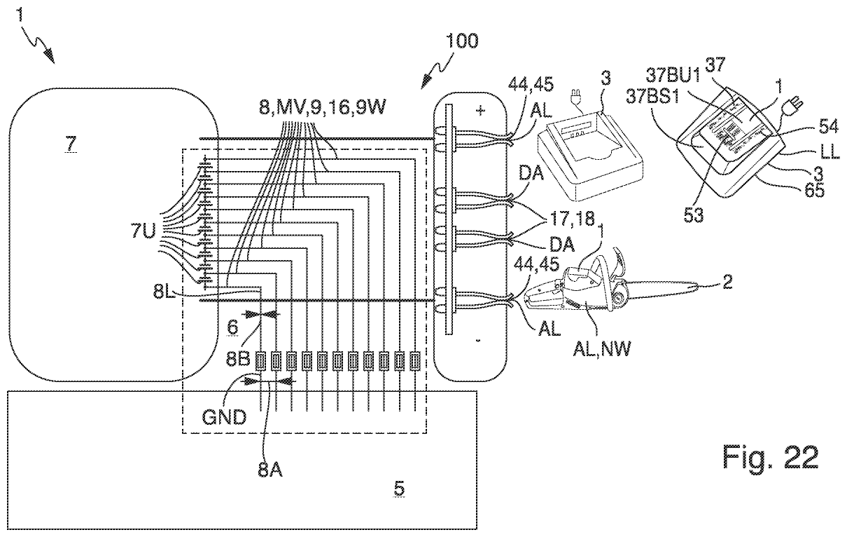

FIGS. 1, 2, 6, 7, 9 and 12 to 22 show a rechargeable battery pack 1 according to the invention. The rechargeable battery pack 1 is designed to supply, in particular supplies, electrical drive power AL to an electrically driven piece of work equipment 2, as shown in FIG. 22. The rechargeable battery pack 1 comprises rechargeable battery cells 7, electrical cell contactors 23 and an FPC connector 6, as shown in FIGS. 3 to 5 and 8. The cell contactors 23 are electrically connected to the rechargeable battery cells 7. The FPC connector 6 is electrically connected, in particular directly, to each of the cell contactors 23 by means of resistance welding joints WV by means of welding electrodes 24 from above produced.

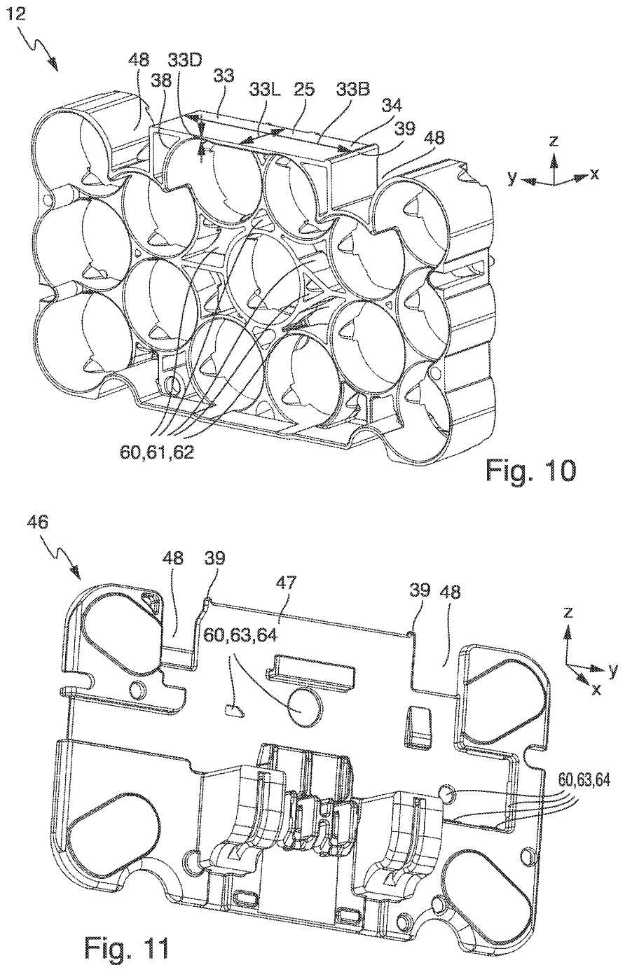

In addition, the rechargeable battery pack 1 has at least one cell holder 12, as shown in FIG. 10. At least the cell holder 12 holds the rechargeable battery cells 7. At least the cell holder 12 is formed as at least one welding support 25 for producing the resistance welding joints WV. At least the cell holder 12 is physically arranged below the cell contactors 23 and the FPC connector 6.

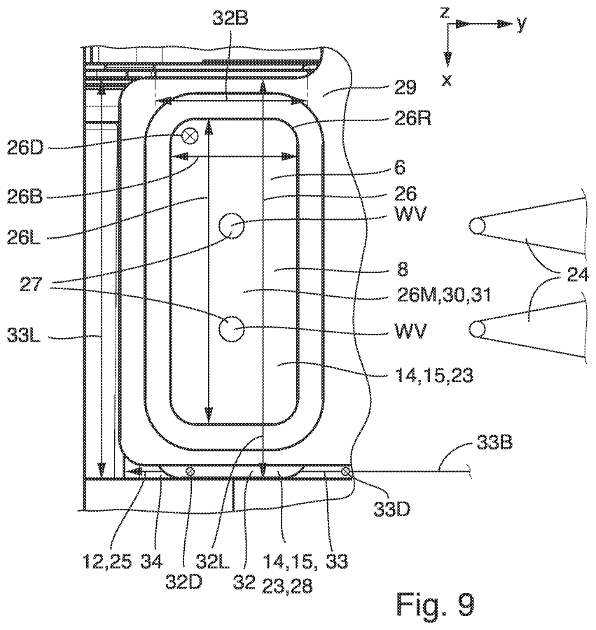

Again in addition or as an alternative, the FPC connector 6 has electrically conductive connector welding surfaces 26, as shown in FIG. 9. The connector welding surfaces 26 each extend continuously between welding points 27 of the resistance welding joints WV with a respective cell contactor 23 of the cell contactors 23. In particular, the cell contactors 23 are physically arranged below the connector welding surfaces 26 to produce the resistance welding joints WV.

FIG. 22 shows a system 100 according to the invention. The system 100 comprises the rechargeable battery pack 1 and comprises an, in particular the, piece of work equipment 2 and/or an electric charger 3. The charger 3 is designed to supply, in particular supplies, electrical charging power LL to the rechargeable battery pack 1.

In the exemplary embodiment shown, the rechargeable battery pack 1 has exactly four cell holders 12. In alternative exemplary embodiments, the rechargeable battery pack may have exactly one, exactly two, exactly three or at least five cell holders.

In detail, the rechargeable battery pack 1 comprises a battery management system 5, as shown in FIGS. 1 to 4 and 22. The battery management system 5 is designed to detect the electrical measurement signals 7U, in particular cell voltages, of the rechargeable battery cells 7. The FPC connector 6 comprises at least electrical measurement conductor paths 8. At least the measurement conductor paths 8 and the cell contactors 23 provide at least electrical measurement connections MV of the battery management system 5 to the rechargeable battery cells 7. At least the measurement conductor paths 8 and the cell contactors 23 are designed to transmit, in particular transmit, at least the measurement signals 7U.

In the exemplary embodiment shown, the rechargeable battery pack 1 has eleven cell contactors 23 and/or the FPC connector 6 has, in particular correspondingly, in particular in a manner equating thereto, eleven measurement conductor paths 8. In alternative exemplary embodiments, the rechargeable battery pack may have fewer or more than eleven cell contactors and/or the FPC connector may, in particular correspondingly, in particular in a manner equating thereto, have fewer or more than eleven measurement conductor paths.

In addition, the cell contactors 23 are electrical cell connectors 14. The cell connectors 14 electrically connect the rechargeable battery cells 7 to one another in series and/or in parallel.

In addition, the cell contactors 23 are rigid, in particular cell contactor plates 28.

Furthermore, the cell holder 12 formed as the welding support 25 continuously extends below at least two cell contactors 23 of the cell contactors 23. The FPC connector 6 does not continuously extend above or below the two cell contactors 23, as indicated in FIGS. 3 to 5 by an arrow P1 for alternative exemplary embodiments.

In addition, the FPC connector 6 has an electrically insulating carrier 29, as shown in FIG. 9. The carrier 29 carries the connector welding surfaces 26 by their edges 26R. The carrier 29 has apertures 30, in particular windows 31, below or above their centres 26M designed for producing the resistance welding joints WV. The cell contactors 23 are physically arranged below the connector welding surfaces 26 to produce the resistance welding joints WV.

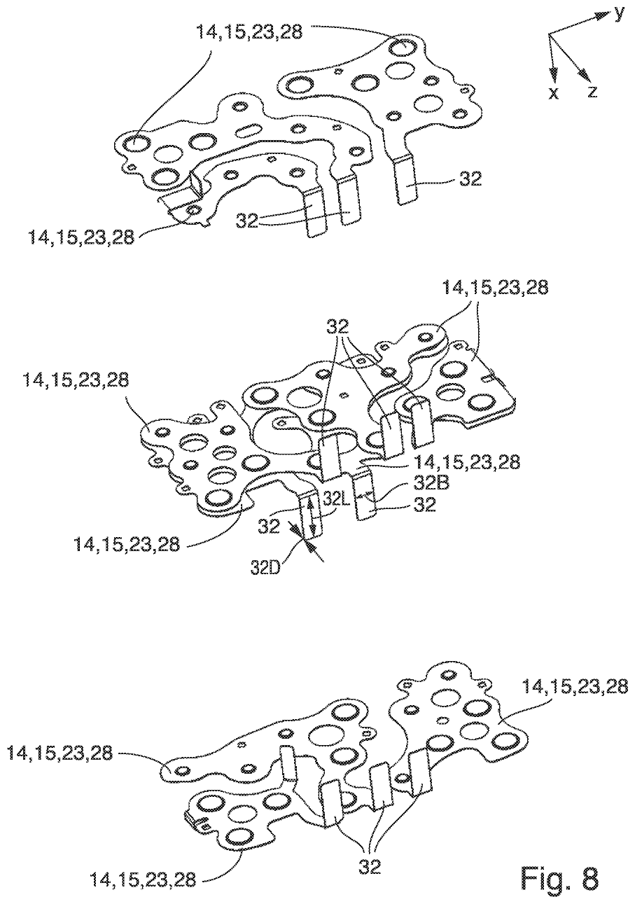

Furthermore, for producing the resistance welding joints WV, the connector welding surfaces 26, in particular each, have a thickness 26D of at most 150 μm, and in particular at least 18 μm, in particular at least 35 μm, in particular 70 μm, and/or a width 26B of at least 1.5 mm and/or at most 10 mm, in particular 4 mm, and/or a length 26L of at least 2 mm and/or at most 30 mm, in particular 12 mm, as shown in FIGS. 9 and 14. In addition or as an alternative, for producing the resistance welding joints WV, electrically conductive contactor welding surfaces 32 of the cell contactors 23 have a thickness 32D of more than 150 μm, and in particular at most 750 μm, in particular 300 μm, and/or a width 32B of at least 3 mm and/or at most 15 mm, in particular 6 mm, and/or a length 32L of at least 8 mm and/or at most 30 mm, in particular 16 mm, as shown in FIGS. 8 and 9. Again in addition or as an alternative, for producing the resistance welding joints WV, electrically insulating support surfaces 33 of the at least one welding support 25 have a thickness 33D of more than 150 μm, and in particular at most 3 mm, in particular 0.9 mm, and/or a width 33B of maximum 43 mm, as shown in FIGS. 9 and 10.

In addition, the electrically insulating contact surfaces 33 of the at least one welding support 25, in particular at least one wall 34 of at least the cell holder 12, continuously extend in each case below the resistance welding joints WV more than between the welding points 27. In particular, a length 33L of the support surfaces 33 is at least as long as the length 26L, 32L of the connector welding surfaces 26 and/or the electrically conductive contactor welding surfaces 32 of the cell contactors 23 for producing the resistance welding joints WV. In particular, the width 33B of the support surfaces 33 is at least as large as the width 26B, 32B of the connector welding surfaces 26 and/or the contactor welding surfaces 32.

Furthermore, the cell contactors 23 comprise the electrically conductive contact welding surfaces 32 for producing the resistance welding joints WV. The contactor welding surfaces 32 each continuously extend below the resistance welding joints WV at least between the respective connector welding surface 26 of the connector welding surfaces 26. In particular, the length 32L of the contactor welding surfaces 32 is at least as long as the length 26L of the connector welding surfaces 26. In particular, the width 32B of the contactor welding surfaces 32 is at least as large as the width 26B of the connector welding surfaces 26.

In addition, the FPC connector 6 has at least one aperture 35, in particular a through-hole 36, as shown in FIGS. 1 to 5. At least the aperture 35 is designed to receive a positioning and/or orientation device for positioning and/or for orientation of the FPC connector 6 with respect to the cell contactors 23 for producing the resistance welding joints WV.

In the exemplary embodiment shown, the FPC connector 6 has exactly two apertures 35. In alternative exemplary embodiments, the FPC connector may have exactly one aperture or at least three apertures.

Furthermore, the FPC connector 6 is of elongate design and is secured by way of its longitudinal ends 6E1, 6E2, in particular for producing the resistance welding joints WV, as shown in FIGS. 1 to 5, 12, 13, 15, 16, 19 and 22. The resistance welding joints WV are physically arranged between the longitudinal ends 6E1, 6E2. In particular, the FPC connector 6 is secured by way of its first longitudinal end 6E1 by means of the battery management system 5 of the rechargeable battery pack 1. In addition or as an alternative, in particular, the FPC connector 6 by way of its second longitudinal end 6E2 is secured by means of at least one electrical pack data contact 17 of the rechargeable battery pack 1, in particular of the FPC connector 6.

In the exemplary embodiment shown, the rechargeable battery pack 1 has exactly two pack data contacts 17. In alternative exemplary embodiments, the rechargeable battery pack may have exactly one pack data contact or at least three pack data contacts.

In addition, the rechargeable battery pack 1 comprises an, in particular cuboid, cell block 4, as shown in FIGS. 1, 2, 6, 7, 12 and 14. The cell block 4 comprises the rechargeable battery cells 7. From above to below is in the direction-z of the cell block 4. In addition or as an alternative, the connector welding surfaces 26 are at least, in particular precisely, physically arranged on a block side 4BU1 of the cell block 4 parallel to the block side 4BU1, in particular a block circumferential side 4BU1.

Furthermore, the rechargeable battery pack 1 comprises a pack housing 37, as shown in FIGS. 14 to 22. The rechargeable battery cells 7, the cell contactors 23, the FPC connector 6 and at least the cell holder 12 are physically arranged in the pack housing 37. At least the cell holder 12 comprises a holding part 38, as shown in FIGS. 1, 2, 6, 7, 10, 14 and 15. At least the holding part 38 holds the rechargeable battery cells 7. At least the cell holder 12 has at least one spacer projection 39 such that the pack housing 37, together with the at least one holding part 38, forms a gap 40. The FPC connector 6 is physically arranged in at least one connector space 41 created by means of the gap 40.

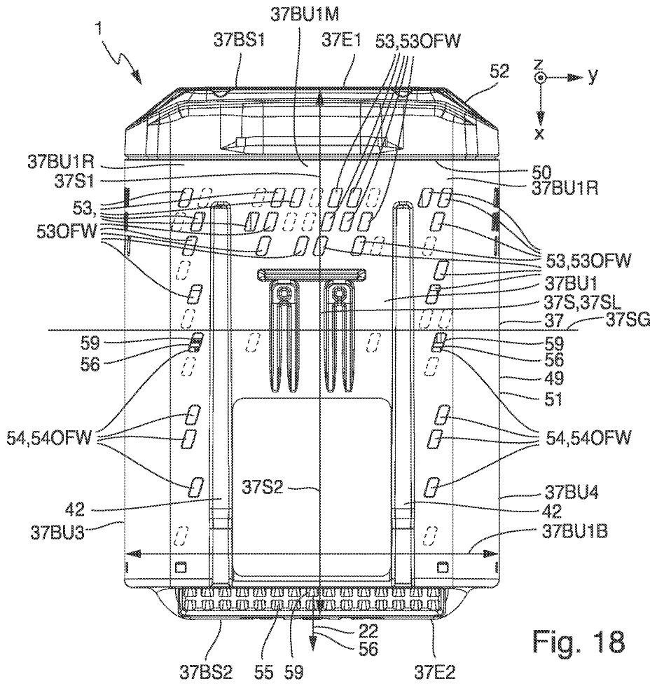

In addition, the rechargeable battery pack 1 comprises the pack housing 37. The rechargeable battery cells 7, the cell contactors 23 and the FPC connector 6 are physically arranged in the pack housing 37. The pack housing 37 has guide grooves 42, as shown in FIGS. 14 and 18. The guide grooves 42 running side by side are designed to guide, in particular they guide, the rechargeable battery pack 1 for mechanical connection with the piece of work equipment 2. The FPC connector 6 is physically arranged between the guide grooves 42 and not next to the guide grooves 42.

In addition, a rated, in particular electrical, voltage of the rechargeable battery pack 1 is at least 10 V, in particular at least 18 V, and/or at most 100 V, in particular at most 72 V, in particular 36 V.

In addition or as an alternative, the, in particular maximum, drive power AL and/or the, in particular maximum, charging power LL, in particular a continuous power or peak power, is at least 10 watts (W), in particular at least 100 W, in particular at least 1 kW (kilowatt), in particular at least 2 kW, and/or at most 10 kW, in particular at most 5 kW, in particular at most 4 kW, in particular 3 kW.

Again in addition or as an alternative, a maximum, in particular electrical, rated energy content of the battery pack 1 is at least 10 Wh (watt hours), in particular at least 100 Wh, in particular at least 200 Wh, and/or at most 4000 Wh, in particular at most 2000 Wh, in particular at most 1000 Wh, in particular at most 500 Wh, in particular 340 Wh.

Again in addition or as an alternative, the rechargeable battery pack 1 has a height or a thickness, in particular in the direction z, of at least 2.5 centimetres (cm) and/or at most 10 cm, in particular 5 cm, and/or a width, in particular in the direction y, of at least 5 cm and/or at most 20 cm, in particular 10 cm, and/or a depth or length, particularly in the direction x, of at least 7.5 cm and/or at most 30 cm, in particular 15 cm.

As the exemplary embodiments shown and explained above make clear, the invention provides an advantageous rechargeable battery pack for supplying electrical drive power to an electrically driven piece of work equipment and an advantageous system comprising the rechargeable battery pack, which have improved properties.

Furthermore, in addition to the claims mentioned below under “What is Claimed is”, additional or alternative claims may be:
1. Rechargeable battery pack (1) for supplying electrical drive power (AL) to an electrically driven piece of work equipment (2),
   wherein the rechargeable battery pack (1) comprises an, in particular cuboid, cell block (4), a battery management system (5) and an FPC connector (6),
   wherein the cell block (4) has rechargeable battery cells (7),
   wherein the battery management system (5) is designed to detect electrical measurement signals (7U), in particular cell voltages, of the rechargeable battery cells (7), and
   wherein the FPC connector (6) comprises at least electrical measurement conductor paths (8),
   wherein at least the measurement conductor paths (8) provide at least electrical measurement connections (MV) of the battery management system (5) to the rechargeable battery cells (7), and
   wherein at least the measurement conductor paths (8) are designed to transmit at least the measurement signals (7U),
   wherein the FPC connector (6) has electrical overcurrent protection fuses (9) which are designed to interrupt at least the measurement conductor paths (8), in particular in each case, to protect the battery management system (5) against an electrical overcurrent, and
   wherein the FPC connector (6) extends at least on a first block circumferential side (4BU1) of the cell block (4) over more than 50%, in particular over 100%, of a distance (4S) from a first end (E1) of the block circumferential side (4BU1), which adjoins a first block front side (4BS1) of the cell block (4), to a second end (E2) of the block circumferential side (4BU1), which adjoins a second block front side (4BS2) of the cell block (4), wherein the second block front side (4BS2) is located opposite the first block front side (4BS1).
2. Rechargeable battery pack (1) according to claim 1,
   wherein the FPC connector (6) extends continuously from the block circumferential side (4BU1) to the second block front side (4BS2), and in particular a second block circumferential side (4BU2) of the cell block (4), wherein the second block circumferential side (4BU2) is located opposite the first block circumferential side (4BU1), and/or in particular from the first block front side (4BS1) to the first block circumferential side (4BU1).
3. Rechargeable battery pack (1) according to claim 1 or 2,
   wherein the battery management system (5) is physically arranged on the first block front side (4BS1),
   in particular wherein the battery management system (5) has at least one, in particular rigid, system circuit board (13) which is physically arranged with its system board plane (13E) parallel to the first block front side (4BS1).
4. Rechargeable battery pack (1) according to any one of claims 1 to 3,
   wherein the FPC connector (6) is secured to the battery management system (5), in particular wherein at least the measurement conductor paths (8) are each soldered to the battery management system (5).
5. Rechargeable battery pack (1) according to any one of claims 1 to 4,
   wherein the rechargeable battery pack (1) has electrical cell connectors (14), in particular cell connector plates (15), which electrically connect the rechargeable battery cells (7) to one another in series and/or in parallel, wherein the FPC connector (6) is secured to each of the cell connectors (14), in particular, wherein the measurement conductor paths (8) are each connected in a materially bonded manner, in particular resistance-welded, to the cell connectors (14).
6. Rechargeable battery pack (1) according to any one of claims 1 to 5,
   wherein the overcurrent protection fuses (9) are conductor path fuses (16) which are integrally formed by at least the measurement conductor paths (8).
7. Rechargeable battery pack (1) according to Claim 6,
   wherein at least the conductor path fuses (16) have no taper, in particular no change in width and/or thickness, and/or no meandering structure.
8. Rechargeable battery pack (1) according to any one of claims 1 to 7,
   wherein at least the measurement conductor paths (8), in particular the conductor path fuses (16), have a width (8B) of at least 50 μm, in particular at least 150 μm and/or at most 500 μm, in particular 300 μm, and/or a thickness (8D) of at least 18 μm, in particular at least 35 μm and/or at most 150 μm, in particular 70 μm, and/or a length (8L) of at least 5 mm, in particular at least 10 mm, and/or
   wherein the overcurrent protection fuses (9) have an interruption current value (9W), wherein the interruption current value (9W) is at most 25 A, in particular at most 12.5 A, and/or wherein the interruption current value (9W) is lower than a rated current value (NW) of the drive power (AL), in particular wherein the interruption current value (9W) is less than 50%, in particular less than 25%, of the rated current value (NW).
9. Rechargeable battery pack (1) according to any one of claims 1 to 8,
   wherein one overcurrent protection fuse (9) of the overcurrent protection fuses (9) is formed for interrupting a measurement conductor path (8) of the measurement conductor paths (8) at a ground reference potential (GND).
10. Rechargeable battery pack (1) according to any one of claims 1 to 9,
   wherein the battery management system (5) is designed to send data (DA) to the piece of work equipment (2) and/or to receive data (DA) from the piece of work equipment (2),
   wherein the rechargeable battery pack (1), in particular the FPC connector (6), has at least one electrical pack data contact (17), in particular a plug connector (18), which is designed to touch an electrical equipment data contact of the piece of work equipment (2), and
   wherein the fpc connector (6) has at least one electrical data conductor path (19),
   wherein at least the data conductor path (19) provides at least one electrical data connection (DV) of the battery management system (5) to the pack data contact (17), and
   wherein at least the data conductor path (19) is designed to transmit the data (DA).
11. Rechargeable battery pack (1) according to any one of claims 1 to 10,
   wherein the FPC connector (6) has a connector aperture (20), in particular a connector hole (21), which is designed to have cooling air (22) of the rechargeable battery cells (7) flow through it, wherein at least one measurement conductor path of the measurement conductor paths and/or the data conductor path (19) extend/extends at least to the connector aperture (20).
12. Rechargeable battery pack (1) according to any one of claims 1 to 11,
   wherein at least the measurement conductor paths (8) have a minimum distance (8A) between one another of at most 2 mm, in particular at most 500 μm, in particular 300 μm, and/or
   wherein the FPC connector (6) has a minimum width (6B) of at most 10 mm, in particular 3.5 mm.
13. System (100) comprising:
   a rechargeable battery pack (1) according to any one of claims 1 to 12, and
   a piece of work equipment (2) and/or an electric charger (3) designed to supply electrical charging power (LL) to the rechargeable battery pack (1).

In addition to the claims mentioned under “What is Claimed is”, additional or alternative claims may be:
1. Rechargeable battery pack (1) for supplying electrical drive power (AL) to an electrically driven piece of work equipment (2),
   wherein the rechargeable battery pack (1) has rechargeable battery cells (7), an FPC connector (6) and a pack housing (37),
   wherein the FPC connector (6) is electrically connected to the rechargeable battery cells (7), and
   wherein the rechargeable battery cells (7) and the FPC connector (6) are physically arranged in the pack housing (37),
characterized
   in that the pack housing (37) has guide grooves (42) which running side by side are designed to guide the rechargeable battery pack (1) for mechanical connection with the piece of work equipment (2), wherein the FPC connector (6) is physically arranged between the guide grooves (42) and not next to the guide grooves (42), and/or
   in that the rechargeable battery pack (1) has at least one cell holder (12), wherein at least the cell holder (12) is physically arranged in the pack housing (37), wherein at least the cell holder (12) has at least one holding part (38), wherein at least the holding part (38) holds the rechargeable battery cells (7), and wherein at least the cell holder (12) has at least one spacer projection (39) such that the pack housing (37), together with the at least one holding part (38), forms a gap (40), wherein the FPC connector (6) is physically arranged in at least one connector space (41) created by means of the gap (40).
2. Rechargeable battery pack (1) according to claim 1,
   wherein the rechargeable battery pack (1) has a power rail (43), wherein the power rail (43) is designed to transmit the drive power (AL), wherein the power rail (43) is physically arranged in the pack housing (37), and wherein the power rail (43) runs next to the FPC connector (6) and/or below a guide groove (42) of the guide grooves (42).
3. Rechargeable battery pack (1) according to claim 1 or 2,
   wherein the rechargeable battery pack (1) has at least one electrical pack power contact (44), in particular a plug connector (45), wherein the pack power contact (44) is designed to touch an electrical equipment power contact of the piece of work equipment (2) for transmitting the drive power (AL), and/or wherein the rechargeable battery pack (1), in particular the FPC connector (6), has at least one electrical pack data contact (17), in particular a plug connector (18), wherein the pack data contact (17) is designed to touch an electrical equipment data contact of the piece of work equipment (2) for transmitting data (DA) between the rechargeable battery pack (1) and the piece of work equipment (2), and
   wherein the rechargeable battery pack (1) has a contact plate (46), wherein the contact plate (46) is physically arranged in the pack housing (37), wherein the contact plate (46) has a carrier part (47), wherein the carrier part (47) carries the pack power contact (44) and/or the pack data contact (17), and wherein the contact plate (46) has at least one spacer projection (39) such that the pack housing (37), together with the carrier part (47), forms the gap (40).
4. Rechargeable battery pack (1) according to any one of claims 1, 2 or 3,
   wherein at least the cell holder (12), and in particular the contact plate (46), has notches (48) in which the guide grooves (42), and in particular the power rail (43), are physically arranged.
5. Rechargeable battery pack (1) according to any one of claims 1 to 4,
   wherein at least the spacer projection (39) and/or the connector space (41) are physically arranged between the guide grooves (42) and not next to the guide grooves (42), and/or
   wherein the FPC connector (6) and/or the connector space (41) is/are physically arranged between spacer projections (39) and not next to the spacer projections (39).
6. Rechargeable battery pack (1) according to any one of claims 1 to 5,
   wherein the pack housing (37) has a housing container (49) which has an insertion opening (50) through which the rechargeable battery cells (7), the FPC connector (6) and at least the cell holder (12) are inserted into the housing container (49), wherein at least the cell holder (12) comprises at least the spacer projection (39) such that a container wall (51) of the housing container (49), together with the at least one holding part (38), forms the gap (40),
   in particular wherein the pack housing (37) has a housing cover (52) which closes the insertion opening (50) of the housing container (49).
7. Rechargeable battery pack (1) according to any one of claims 1 to 6,
   wherein the rechargeable battery pack (1) has an, in particular cuboid, cell block (4), wherein the cell block (4) comprises the rechargeable battery cells (7), and wherein the cell block (4) is physically arranged in the pack housing (37), and
   wherein the FPC connector (6) and the guide grooves (42) are physically arranged on a block side (4BU1), in particular a block circumferential side (4BU1), of the cell block (4) parallel to the block side (4BU1),
   in particular wherein the cell block (4), in particular the cuboid shape thereof, is formed by at least the cell holder (12), in particular at least the holding part (38), and in particular the held rechargeable battery cells (7).
8. Rechargeable battery pack (1) according to any one of claims 1 to 7,
   wherein the rechargeable battery pack (1) has electrical cell contactors (23), in particular cell contactor plates (28), wherein the cell contactors (23) are physically arranged in the pack housing (37), and wherein the cell contactors (23) are electrically connected to the rechargeable battery cells (7),
   wherein the FPC connector (6) is electrically connected to the cell contactors (23) in each case by means of resistance welding joints (WV), and
   wherein the resistance welding joints (WV) are physically arranged between the guide grooves (42) and not next to the guide grooves (42), and in particular on the block side (4BU1) of the cell block (4) parallel to the block side (4BU1).
9. Rechargeable battery pack (1) according to any one of claims 1 to 8,
   wherein the rechargeable battery pack (1) has electrical cell contactors (23), in particular cell contactor plates (28), wherein the cell contactors (23) are physically arranged in the pack housing (37), and wherein the cell contactors (23) are electrically connected to the rechargeable battery cells (7),
   wherein the FPC connector (6) is electrically connected to the cell contactors (23) in each case by means of resistance welding joints (WV) by means of welding electrodes (24) from above produced,
      wherein at least the cell holder (12), in particular at least the holding part (38), is formed as at least one welding support (25) for producing the resistance welding joints (WV), and wherein at least the cell holder (12) is arranged physically below the cell contactor (23) and the FPC connector (6), and
      wherein at least the spacer projection (39) is physically arranged above the at least one welding support (25) and/or next to the FPC connector (6).
10. Rechargeable battery pack (1) according to any one of claims 1 to 9,
   wherein the FPC connector (6) is of elongate design and is secured by means of its longitudinal ends (6E1, 6E2), in particular to produce the resistance welding joints (WV), in particular between which the resistance welding joints (WV) are physically arranged,
   in particular wherein the FPC connector (6) is secured by way of its first longitudinal end (6E1) by means of a battery management system (5) of the rechargeable battery pack (1), and/or in particular wherein the FPC connector (6) is secured by way of its second longitudinal end (6E2) by means of at least one electrical pack data contact (17) of the rechargeable battery pack (1), in particular of the FPC connector (6).
11. Rechargeable battery pack (1) according to any one of claims 1 to 10,
   wherein the rechargeable battery pack (1) has an, in particular cuboid, cell block (4), wherein the cell block (4) comprises the rechargeable battery cells (7), and wherein the cell block (4) is physically arranged in the pack housing (37), and
   wherein the FPC connector (6) extends at least on a first block circumferential side (4BU1) of the cell block (4) over more than 50%, in particular over 100%, of an extent (4S) from a first end (E1) of the block circumferential side (4BU1), which adjoins a first block front side (4BS1) of the cell block (4), to a second end (E2) of the block circumferential side (4BU1), which adjoins a second block front side (4BS2) of the cell block (4), wherein the second block front side (4BS2) is located opposite the first block front side (4BS1),
   in particular wherein the FPC connector (6) extends continuously from the block circumferential side (4BU1) to the second block front side (4BS2), and in particular a second block circumferential side (4BU2) of the cell block (4), wherein the second block circumferential side (4BU2) is located opposite the first block circumferential side (4BU1), and/or in particular from the first block front side (4BS1) to the first block circumferential side (4BU1),
   in particular wherein the cell block (4), in particular the cuboid shape thereof, is formed by at least the cell holder (12), in particular at least the holding part (38), and in particular the held rechargeable battery cells (7).
12. Rechargeable battery pack (1) according to any one of claims 1 to 11,
   wherein the rechargeable battery pack (1) has a battery management system (5), wherein the battery management system (5) is designed to detect electrical measurement signals (7U), in particular cell voltages, of the rechargeable battery cells (7), and wherein the battery management system (5) is physically arranged in the pack housing (37), and
   wherein the FPC connector (6) comprises at least electrical measurement conductor paths (8),
   wherein at least the measurement conductor paths (8) provide at least electrical measurement connections (MV) of the battery management system (5) to the rechargeable battery cells (7), and
   wherein at least the measurement conductor paths (8) are designed to transmit at least the measurement signals (7U).
13. Rechargeable battery pack (1) according to any one of claims 1 to 12,
   wherein the FPC connector (6) has an electrically insulating carrier (29) which has a thickness (29D) of at most 500 μm, and in particular at least 50 μm, in particular 200 μm.
14. System (100) comprising:
   a rechargeable battery pack (1) according to any one of claims 1 to 13, and
   a piece of work equipment (2) and/or an electric charger (3) designed to supply electrical charging power (LL) to the rechargeable battery pack (1).

In addition to the claims mentioned under “What is Claimed is”, additional or alternative claims may be:
1. Rechargeable battery pack (1) for supplying electrical drive power (AL) to an electrically driven piece of work equipment (2),
   wherein the rechargeable battery pack (1) has rechargeable battery cells (7) and a block-shaped, in particular cuboid, pack housing (37),
   wherein the rechargeable battery cells (7) are physically arranged in the pack housing (37),
   wherein the pack housing (37) has, on at least a first circumferential side of the housing (37BU1), first air inlet openings (53) along a first half (37S1) of a extent (37S) and second air inlet openings (54) along a second half (37S2) of the extent (37S) and on a, in particular exactly one, second housing front side (37BS2) air outlet openings (55) for air flow (56) in the pack housing (37) from the first air inlet openings (53) and the second air inlet openings (54) in each case past the rechargeable battery cells (7) to the air outlet openings (55) for air cooling of the rechargeable battery cells (7),
   wherein the extent (37S) is from a first end (37E1) of the housing circumferential side (37BU1), which adjoins a first housing front side (37BS1) of the pack housing (37), to a second end (37E2) of the housing circumferential side (37BU1), which adjoins the second housing front side (37BS2) of the pack housing (37), wherein the second housing front side (37BS2) is located opposite the first housing front side (37BU1),
   wherein the first half (37S1) adjoins the first housing front side (37BS1),
   wherein the second half (37S2) adjoins the second housing front side (37BS2), and
   wherein a ratio (53OFW/54OFW) of first opening surface values (53OFW) of the first air inlet openings (53) to the second opening surface values (54OFW) of the second air inlet openings (54) is in a value range of 2, in particular 5, to 20, in particular up to 15, in particular 8.
2. Rechargeable battery pack (1) according to claim 1,
   wherein the first air inlet openings (53) and the second air inlet openings (54) are physically arranged and wherein the ratio (53OFW/54OFW) is such that the flow resistance values for the air flow (56) in the pack housing (37) from the first air inlet openings (53) and the second air inlet openings (54) past the rechargeable battery cells (7) to the air outlet openings (55) are identical in each case and/or that the air cooling of the rechargeable battery cells (7) is homogeneous.
3. Rechargeable battery pack (1) according to claim 1 or 2,
   wherein the first air inlet openings (53) are distributed along the first half (37S1) over at least 50%, in particular 60%, of the first half (37S1) and/or physically arranged up to a boundary (37SG) with the second half (37S2), and/or
   wherein the second air inlet openings (54) are distributed along the second half (37S2) over at least 50%, in particular 60%, in particular 70%, of the second half (37S2) and/or physically arranged from the boundary (37SG) with the first half (37S1) onwards, and/or
   wherein the rechargeable battery cells (7) are distributed along the first half (37S1) over at least 50%, in particular 60%, in particular 70%, of the first half (37S1) and/or physically arranged up to the boundary (37SG) with the second half (37S2), and/or
   wherein the rechargeable battery cells (7) are distributed along the second half (37S2) over at least 50%, in particular 60%, in particular 70%, in articular 80%, of the second half (37S2) and/or physically arranged from the boundary (37SG) with the first half (37S1) onwards.
4. Rechargeable battery pack (1) according to any one of claims 1 to 3,
   wherein the rechargeable battery pack (1) has an, in particular cuboid, cell block (4), wherein the cell block (4) is physically arranged in the pack housing (37), and wherein the cell block (4) has a first sub-block (57) and a second sub-block (58), wherein the first sub-block (57) and the second sub-block (58) comprise the rechargeable battery cells (7) and are physically arranged sequentially along the extent (37S).
5. Rechargeable battery pack (1) according to any one of claims 1 to 4,
   wherein at least 25%, in particular 33%, of the first air inlet openings (53) and/or at least 50%, in particular at least 65%, in particular at least 80%, of the second air inlet openings (54) are physically arranged on the first housing circumferential side (37BU1), wherein a width (37BU1B) orthogonal to the extent (37S) of the first housing circumferential side (37BU1) is at least as large as widths (37BU2B, 37BU3B, 37BU4B) of all further housing circumferential sides (37BU2, 37BU3, 37BU4) of the pack housing (37), in particular wherein a length (37SL) of the section (37S) is greater than all the widths (37BU1B, 37BU2B, 37BU3B, 37BU4B), and/or
   wherein the pack housing (37) has air inlet openings (53, 54) on at least one further housing circumferential side (37BU2, 37BU3, 37BU4), in particular all other housing circumferential sides (37BU2, 37BU3, 37BU4) of the pack housing (37).
6. Rechargeable battery pack (1) according to any one of claims 1 to 5,
   wherein the first air inlet openings (53) are physically arranged along a width (37BU1B) orthogonal to the extent (37S) of the first housing circumferential side (37BU1) at edges (37BU1R) and in a centre (37BU1M) of the first housing circumference side (37BU1), and/or
   wherein the second air inlet openings (54) are physically arranged along the width (37BU1B) orthogonal to the extent (37S) of the first housing circumferential side (37BU1) at the edges (37BU1R) and not in the centre (37BU1M) of the first housing circumference side (37BU1).
7. Rechargeable battery pack (1) according to any one of claims 1 to 6,
   wherein the rechargeable battery pack (1) comprises an, in particular cuboid, cell block (4), wherein the cell block (4) comprises the rechargeable battery cells (7), and
   wherein the pack housing (37) is formed and wherein the cell block (4) is formed and physically arranged in the pack housing (37) such that at least one air duct (59) between the pack housing (37) and the cell block (4), in particular the rechargeable battery cells (7), passes the cell block (4) at least partially along the extent (37S), in particular on at least the first housing circumferential side (37BU1), and in particular at least one further housing circumferential side (37BU2, 37BU3, 37BU4) of the pack housing (37), in particular all other housing circumferential sides (37BU2, 37BU3, 37BU4) of the pack housing (37), is formed for the air flow (56).
8. Rechargeable battery pack (1) according to any one of claims 1 to 7,
   wherein the rechargeable battery pack (1) comprises an, in particular cuboid, cell block (4), wherein the cell block (4) comprises the rechargeable battery cells (7), and wherein the cell block (4) is formed and physically arranged in the pack housing (37) such that at least one air duct (60) is formed for the air flow (56) through the cell block (4) at least partially along the extent (37S), in particular up to the second housing front side (37BS2).
9. Rechargeable battery pack (1) according to claim 8,
   wherein the rechargeable battery pack (1) has at least one cell holder (12), a contact plate (46) and/or an FPC connector (6), wherein at least the cell holder (12), the contact plate (46) and/or the FPC connector (6) is/are physically arranged in the pack housing (37) on the cell block (4) and/or on the second housing front side (37BS2), in particular parallel to the second housing front side (37BS2),
   wherein at least the cell holder (12) holds the rechargeable battery cells (7), and wherein the cell holder (12) has a holder aperture (61), in particular a holder hole (62), wherein the air duct (60) is formed through at least the holder aperture (61), and/or
   wherein the contact plate (46) carries at least one electrical pack power contact (44) and/or at least one electrical pack data contact (17) of the rechargeable battery pack (1), and wherein the contact plate (46) has a plate aperture (63), in particular a plate hole (64), wherein the air duct (60) is formed through at least the plate aperture (63), and/or
   wherein the FPC connector (6) has a connector aperture (20), in particular a connector hole (21), wherein the air duct (60) is formed through the at least one connector aperture (20), wherein at least one measurement conductor path and/or a data conductor path (19) of the FPC connector (6) extend/extends at least to the connector aperture (20).
10. Rechargeable battery pack (1) according to claim 9,
   wherein the holder aperture (61), the plate aperture (63), the connector aperture (20) and the air outlet openings (55) are arranged sequentially along the extent (37S).
11. Rechargeable battery pack (1) according to any one of claims 1 to 10,
   wherein the rechargeable battery pack (1) has at least one electrical pack power contact (44), in particular a plug connector (45), wherein the pack power contact (44) is designed to make contact with an electrical equipment power contact of the piece of work equipment (2) for transmitting the drive power (AL), and/or wherein the rechargeable battery pack (1) has at least one electrical pack data contact (17), in particular a plug connector (18), wherein the pack data contact (17) is designed to make contact with an electrical equipment data contact of the piece of work equipment (2) for transmitting data (DA) between the rechargeable battery pack (1) and the piece of work equipment (2), and
   wherein the pack power contact (44) and/or the pack data contact (17) are/is physically arranged on, in particular precisely, the second housing front side (37BS2), in particular further away from the first housing circumferential side (37BU1) than the air outlet openings (55).
12. Rechargeable battery pack (1) according to any one of claims 1 to 11,
   wherein the rechargeable battery cells (7) are, in particular elongate, round cells (10), in particular wherein the round cells (10) are physically arranged with their longitudinal cell axes (10L) parallel to the extent (37S), and in particular parallel to one another in at least one common cell plane (10E).
13. Rechargeable battery pack (1) according to any one of claims 1 to 12,
   wherein the pack housing (37) has a housing container (49) which has an insertion opening (50) through which the rechargeable battery cells (7) are inserted into the housing container (49), and
   wherein the pack housing (37) has a housing cover (52) which closes the insertion opening (50) of the housing container (49),
   wherein the housing container (49) and not the housing cover (52) comprises the first air inlet openings (53), the second air inlet openings (54) and the air outlet openings (55),
   in particular wherein the housing cover (52) and the housing container (49) are physically arranged sequentially along the extent (37S).
14. System (100) comprising:
   a rechargeable battery pack (1) according to any one of claims 1 to 13, and
   a piece of work equipment (2) and/or an electric charger (3) designed to supply electrical charging power (LL) to the rechargeable battery pack (1).
15. System (100) According to claim 14,
   wherein the piece of work equipment and/or the charger (3) and the rechargeable battery pack (1) are designed to receive the rechargeable battery pack (1) by way of the piece of work equipment and/or the charger (3) and wherein the piece of work equipment and/or the charger (3) have/has a fan (65) such that the fan (65) is designed to generate the air flow (56) in the pack housing (37), wherein the fan (65) is designed to suck cooling air (22) out of the air outlet openings (55) of the rechargeable battery pack (1) received by way of the piece of work equipment and/or the charger (3), and in particular such that the first air inlet openings (53) and the second air inlet openings (54) are free for suction into the first air inlet openings (53) and the second air inlet openings (54) on at least the first housing circumferential side (37BU1).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rechargeable battery pack for supplying electrical drive power to an electrically driven piece of work equipment, comprising:
rechargeable battery cells;
electrical cell contactors; and
an FPC connector;
wherein the cell contactors are electrically connected to the rechargeable battery cells, and
wherein the FPC connector is electrically connected to the cell contactors in each case via resistance welding joints produced by way of welding electrodes from above;
at least one cell holder, wherein the cell holder holds the rechargeable battery cells, wherein the cell holder is formed as at least one welding support for producing the resistance welding joints, and wherein the cell holder is arranged physically below the cell contactor and the FPC connector, and/or
the FPC connector has electrically conductive connector welding surfaces, wherein the connector welding surfaces each extend continuously between welding points of the resistance welding joints with a respective cell contactor of the cell contactors, wherein the cell contactors are physically arranged below the connector welding surfaces to produce the resistance welding joints.

2. The rechargeable battery pack according to claim 1, further comprising:
a battery management system designed to detect electrical measurement signals of the rechargeable battery cells,
wherein the FPC connector comprises electrical measurement conductor paths,
wherein the measurement conductor paths and the cell contactors provide electrical measurement connections of the battery management system to the rechargeable battery cells, and
wherein the measurement conductor paths and the cell contactors are designed to transmit the measurement signals.

3. The rechargeable battery pack according to claim 1,
wherein the cell contactors are electrical cell connectors which electrically connect the rechargeable battery cells to one another in series and/or in parallel.

4. The rechargeable battery pack according to claim 1,
wherein the cell contactors are rigid cell contact plates.

5. The rechargeable battery pack according to claim 1,
wherein the cell holder formed as the welding support continuously extends below at least two cell contactors, and
wherein the FPC connector does not extend continuously above or below the two cell contactors.

6. The rechargeable battery pack according to claim 1,
wherein the FPC connector has an electrically insulating carrier which carries the connector welding surfaces at their edges and has apertures below or above their centers designed for producing the resistance welding joints, and
wherein the cell contactors are physically arranged below the connector welding surfaces to produce the resistance welding joints.

7. The rechargeable battery pack according to claim 1, wherein at least one of:
the connector welding surfaces for producing the resistance welding joints have a thickness of at least 150μm, and/or a width of at least 1.5 mm and/or at most 10 mm, and/or a length of at least 2 mm and/or at most 30 mm, or
electrically conductive contactor welding surfaces of the cell contactors for producing the resistance welding joints have a thickness of more than 150μm, and/or a width of at least 3 mm and/or at most 15 mm, and/or a length of at least 8 mm and/or at most 30 mm, and/or
electrically insulating support surfaces of the at least one welding support for producing the resistance welding joints have a thickness of more than 150 μm, and/or a width of at most 43 mm.

8. The rechargeable battery pack according to claim 1,
wherein electrically insulating support surfaces of the at least one welding support, each continuously extend below the resistance welding joints more than between the welding points,
wherein a length of the support surfaces is at least as large as a length of the connector welding surfaces and/or electrically conductive contactor welding surfaces of the cell contactors for producing the resistance welding joints, and
wherein a width of the support surfaces is at least as large as a width of the connector welding surfaces and/or the contactor welding surfaces.

9. The rechargeable battery pack according to claim 1,
wherein the cell contactors have electrically conductive contactor welding surfaces for producing the resistance welding joints which each continuously extend below the resistance welding joints at least between the respective connector welding surface of the connector welding surfaces,
wherein a length of the contactor welding surfaces is at least as large as a length of the connector welding surfaces, and
wherein a width of the contactor welding surfaces is at least as large as a width of the connector welding surfaces.

10. The rechargeable battery pack according to claim 1,
wherein the FPC connector has at least one aperture, which is designed to receive a positioning and/or orientation device for positioning and/or orientation of the FPC connector with respect to the cell contactors for producing the resistance welding joints.

11. The rechargeable battery pack according to claim 1,
wherein the FPC connector is of elongate design and is secured by its longitudinal ends, between which longitudinal ends the resistance welding joints are physically arranged.

12. The rechargeable battery pack according to claim 11,
wherein the FPC connector is secured by way of a first longitudinal end by a battery management system of the rechargeable battery pack, and/or
wherein the FPC connector is secured by way of a second longitudinal end by at least one electrical pack data contact of the rechargeable battery pack.

13. The rechargeable battery pack according to claim 1,
wherein the rechargeable battery pack comprises a cuboid cell block which comprises the rechargeable battery cells, and
wherein from above to below is in the direction (-z) of the cell block, and/or wherein the connector welding surfaces are physically arranged at least on a block side of the cell block parallel to the block side.

14. The rechargeable battery pack to claim 1, further comprising:
a pack housing, wherein the rechargeable battery cells, the cell contactors, the FPC connector and at least the cell holder are physically arranged in the pack housing,
wherein the cell holder has at least one holding part, wherein the holding part holds the rechargeable battery cells, and wherein at least the cell holder has at least one spacer projection such that the pack housing, together with the at least one holding part, forms a gap, and
wherein the FPC connector is physically arranged in at least one connector space created by the gap.

15. The rechargeable battery pack according to claim 1, further comprising:
a pack housing, wherein the rechargeable battery cells, the cell contactors and the FPC connector are physically arranged in the pack housing,
wherein the pack housing has guide grooves which, running side by side, are designed to guide the rechargeable battery pack for mechanical connection with the piece of work equipment, and
wherein the FPC connector is physically arranged between the guide grooves and not next to the guide grooves.

16. A system, comprising:
the rechargeable battery pack according to claim 1; and
the electrically driven piece of work equipment and/or an electric charger designed to supply electrical charging power to the rechargeable battery pack.
